(19) United States
(12) Patent Application Publication
(10) Pub. No.: US 2008/0177611 A1
(43) Pub. Date: Jul. 24, 2008

(54) MEANS AND METHODS TO COORDINATE MEETINGS AND GENERATION OF RELATED DOCUMENTS

(76) Inventors: Joshua Paul Sommers, Rohnert Park, CA (US); Phil Paisley, Rohnert Park, CA (US)

Correspondence Address: STEVEN A. NIELSEN;ALLMAN & NIELSEN, P.C, 100 Larkspur Landing Circle, Suite 212, LARKSPUR, CA, 94939, US

(21) Appl. No.: 11/955,395

(22) Filed: Dec. 13, 2007

Related U.S. Application Data
(60) Provisional application No. 60/869,883, filed on Dec. 13, 2006.

(51) Int. Cl. G06Q 10/00

(52) U.S. Cl. 705/8

(57) ABSTRACT

Meetings are coordinated by a meeting coordinator who enters the identity of invitees, possible meeting times and locations and other meeting parameters. Invitees may report their acceptance, rejection and/or personal preferences for meeting times and locations. If all invites respond and a consensus is not reached, the meeting coordinator may change the meeting parameters and initiate another round of invitations and responses. When a consensus is reached, a meeting location is selected, if multiple locations were approved. An agenda and confirmation of the meeting details are distributed. During the meeting, means of recording and displaying statements are provided. Meeting participates may provide contemporaneous written comments to the minutes during the meeting or may add comments or revisions after the meeting.

### CROSS-REFERENCE TO RELATED APPLICATIONS

This application claims the benefit of U.S. provisional patent application “Means and methods to coordinate meetings and generation of related documents” No. 60/869,883 filed on Dec. 13, 2006, which is incorporated herein by reference in its entirety.

### STATEMENT REGARDING FEDERALLY SPONSORED RESEARCH OR DEVELOPMENT

Not Applicable

### REFERENCE TO A SEQUENCE LISTING

Not Applicable

### BACKGROUND OF THE INVENTION

(1) Field of the Invention

The invention generally relates to means and methods of coordinating meetings and generating related documents. More particularly, a database, system server, user interface, and other means and various methods enable the scheduling of meetings and the generation of email communications and the production of meeting notes, minutes, agendas and other related documents and meeting artifacts.

(2) Description of the Related Art

The related art fails to provide the efficiencies, low hardware requirements, user privacy, or ease of use of the present invention. U.S. Pat. No. 7,108,173 to Wang discloses the use of a “scheduling agent” for each user in a complex protocol were scheduling agents consume hardware resources performing negotiations with other scheduling agents, calculating global preference scores, sorting suggestions and passing reserving suggestions. In the real world, busy professionals are not interested in global preference scores and want a fast and definite “yes” or “no” answer to their request for a meeting.

The methodologies, hardware requirements and security risks of Wang are too severe to be of any real world use and fail to provide means of sharing agendas or meeting minutes. Wang requires each potential invitee to input his or her schedule into an autonomous scheduling agent, which is an unrealistic requirement. In the modern business world, meetings often occur between relative strangers or between adversarial participates who are not interested in exposing their computer systems to autonomous scheduling agents that may inadvertently disclose confidential information. For example, in the scheduling of depositions between opposing law firms representing adverse parties in a lawsuit, neither law firm will take any risk in exposing their firm calendar, electronic calendar or other information to opposing counsel.

Currently, depositions and other adversarial meetings are scheduled by phone calls from a scheduling assistant who will call the scheduling assistant of each opposing counsel with alternative dates and meeting times. The scheduling assistant of each opposing counsel will give a yes or no answer to each proposed meeting time and will not divulge the contents of any personal calendar or law firm calendar nor allow access to their firm's private network or computers.

Thus, what is needed in the art are means and methods to efficiently facilitate the scheduling of meetings, employing a user interface and protocol that maximizes information security and is convenient to use.

### BRIEF SUMMARY OF THE INVENTION

The present invention overcomes shortfalls in the related art by providing simple and efficient methods and means for coordinating meetings in a comfortable format similar to the current person-to-person methods used by meeting schedulers and attendees. Unlike the related art, the present invention does not require a user to expose his or her computer system to a scheduling agent, divulge their calendar, calculate scores, or perform complex algorithms.

The methodology of the present invention does not require the installation of any additional software and no information is shared without human intervention. A Meeting Coordinator may access the disclosed system via any web interface and input proposed meeting times, locations and attendees. The Meeting Coordinator may enter a meeting agenda, designate potential attendees as optional or required and may establish a quorum. The system sends electronic mail to all potential meeting attendees. The electronic mail message contains a hyperlink to a page on the system server that allows a potential meeting attendee to view possible dates and times of the proposed meeting and to accept or reject one or several of the proposed meeting times. A potential meeting attendee is not required to offer alternative meeting dates, become a member of the system or disclose personal information.

After all invited attendees have responded to the issued electronic mail message, the system issues an electronic mail message to the Meeting Coordinator with the results of the scheduling attempt. If an inadequate number of attendees accepted the invitations, or if a required attendee failed to accept an invitation, the Meeting Coordinator may reevaluate the situation, take a moment to think, personally contact any key invitee, reassess the situation, adjust the meeting parameters, and cause a new round of meeting invitations to be issued.

The functionality of the disclosed system is enhanced by the Coordination Center comprising My Meetings, My Attendees, My Locations and other functions and user interfaces that facilitate a Meeting Coordinator's work in orchestrating a meeting. Among other functions, the Coordination Center has means to allow a Meeting Coordinator to enter an agenda for a proposed meeting. After receipt of an invitation to attend a meeting, an invitee is lead to a page on the system server or system database wherein potential meeting times and potential meeting locations may be selected. The potential invitee submits her selections which are recorded within the Coordination Center. The disclosed system determines when a consensus has been reached, or when a meeting is not possible. After a “go” or “no go” determination has been made the Meeting Coordinator is notified via email or other means.

In one embodiment, invitees may invite others, known as “sub-invitees” who may accept, decline and/or suggest alternative dates, times and locations for a proposed meeting. The invitee responses are available to the Meeting Coordinator and may be used in the event a meeting consensus is not reached. The disclosed system may survey the invitee data and suggest alternative dates, times and locations to the Meeting Coordinator. The system may store the reported preferences of the invitees as well as the meeting preferences actually practiced by the invitees. Such information may assist the Meeting Coordinator in setting parameters for future meetings, and over time, may assist a Meeting Coordinator is assessing the enthusiasm of the invitees.

The invention may include means and methods of charging and/or collecting money from Meeting Coordinators, invitees or others. Payments on a per meeting basis may be collected or subscriptions to the system may be sold. Advertising space on the various web pages on the system may also be sold.

The invention may include a graphical interface to quickly and intuitively report the number and/or percentage of invitees who have accepted an invitation. As invitees report their availability, various graphs may be generated to assist the Meeting Coordinator in changing the possible meeting parameters. Overlapping lines or bars may be used to illustrate where invitees' schedules intersect.

The invention includes means and methods of producing minutes and meeting notes. Such documents may be approved and/or revised by the participants of the meeting. Voice recognition software or other means may be used to record statements made during meetings. Participants may view the real time transcript of a meeting and type in or otherwise enter corrections or comments. After the meeting, the minutes or notes may be distributed and/or posted upon a web portal or other location.

In one embodiment, in general, the invention may be considered an Internet based business method for coordinating meeting times, dates and locations, inviting attendees and posting agendas and meeting notes. The invention may include an interactive website for managing all functions involved with coordinating a meeting.

These and other objects and advantages will be made apparent when considering the following detailed specification.

### BRIEF DESCRIPTION OF THE DRAWINGS

FIG. 1 is a diagram of the Coordination Center interface.

FIG. 2 is a diagram of the My Meetings interface.

FIG. 3 is a flow chart of meeting orchestration.

### DETAILED DESCRIPTION OF THE INVENTION

The description, which follows, and the embodiments described therein, are provided by way of illustration of an example, or examples of particular embodiments of the principles of the present invention. These examples are provided for the purposes of explanation, and not of limitation, of those principles of the invention. In the description, which follows, like parts are marked throughout the specification and the drawings with the same respective reference numerals. The drawings are not necessarily to scale and in some instances proportions may have been exaggerated in order to more clearly depict certain features of the invention.

### DEFINITIONS

Unless otherwise stated, the terms used herein have the ordinary meeting as used by workers in the art. The following definitions are used herein.

The present invention is sometimes referred to herein as the invention, the system, Meetsauce.com and/or Meetsauce.

A Meeting Coordinator is the individual or entity who is a subscriber or member of the system. The Meeting Coordinator may establish meetings, an agenda, a quorum, the required and optional attendees, and the possible dates, times and locations for each meeting.

Meeting Attendees are the people who are established and invited by the Meeting Coordinator to attend a meeting. Meeting attendees fall into two categories: those whose presence is required in order to hold the meeting, and those whose presence is not required in order to hold the meeting. The former are sometimes referred to as “required” and the later are sometimes referred to as “optional”. Each meeting may have an unlimited number of Attendees. A Meeting Coordinator establishes a Meeting Attendee by entering into the system's database the name, email address, phone number and other information related to the Meeting Attendee.

The Meeting Locations are the date/time/location combinations to potentially hold a meeting. Each meeting may have an unlimited number of Meeting Locations.

A Meeting Quorum is the minimum number of attendees required to hold a meeting.

A Meeting Agenda is a list, document, or other artifact describing the proposed activities, discussion topics and actionable items for a meeting.

Meeting Notes/Minutes is a list, document or other artifact memorializing the events of a meeting and may include an explanation of issued discussed or goals achieved during a meeting.

A Meeting Invitation is an email or other communication that is sent by the Meeting Coordinator to all Meeting Attendees. A Meeting Invitation may contain information about the subject of the meeting and links to the Agenda and possible Meeting Locations.

An Attendee Response is executed by following a link in the Meeting Invitation, wherein each attendee is directed to a web page where they can indicate which Meeting Locations they can and cannot attend and may view the Meeting Agenda, and suggest changes or additions.

A Meeting Consensus is reached when the elements of a Meeting Location have been approved by all required attendees, or in the absence of required attendees, by a number of attendees equaling the Meeting Quorum.

A Meeting Confirmation may be sent after a consensus has been reached on one or more locations and the Meeting Coordinator makes the final decision as to which Meeting Location will be used to hold the meeting. A Meeting Confirmation may be sent via email or other means and may be delivered to all Attendees and may disclose time, location, and other details of the meeting.

User Interface and System Functions

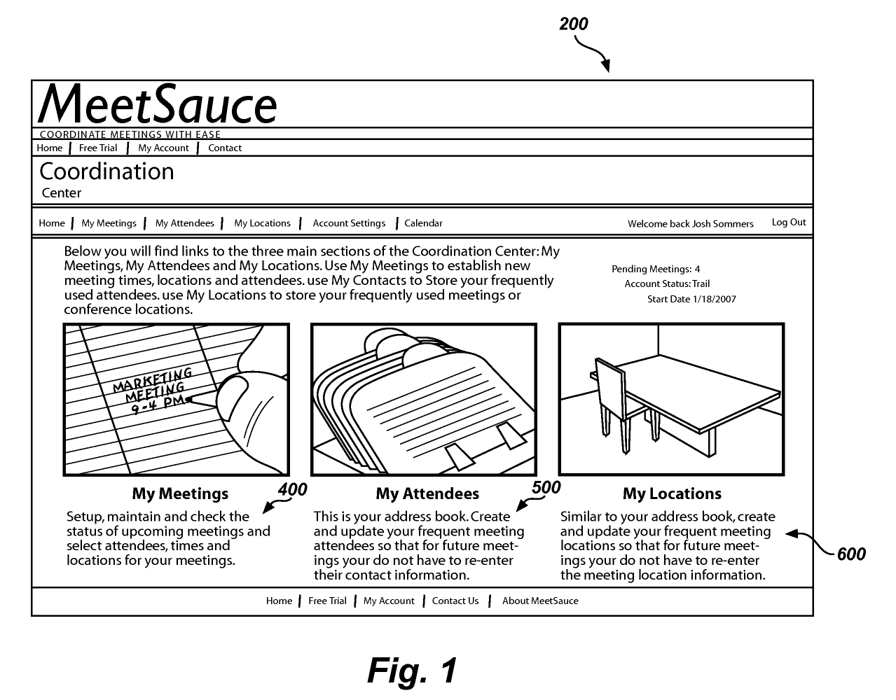

Referring to FIG. 1, the Coordination Center is shown generally as 200 and comprises My Meetings 400, My Attendees 500, My Locations 600, control features and instructions.

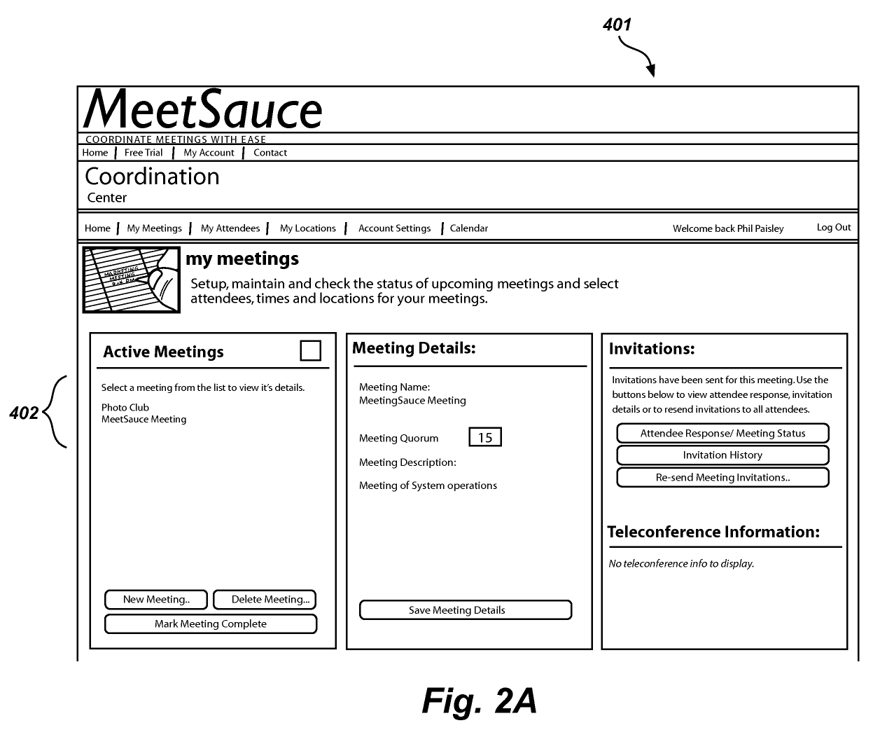

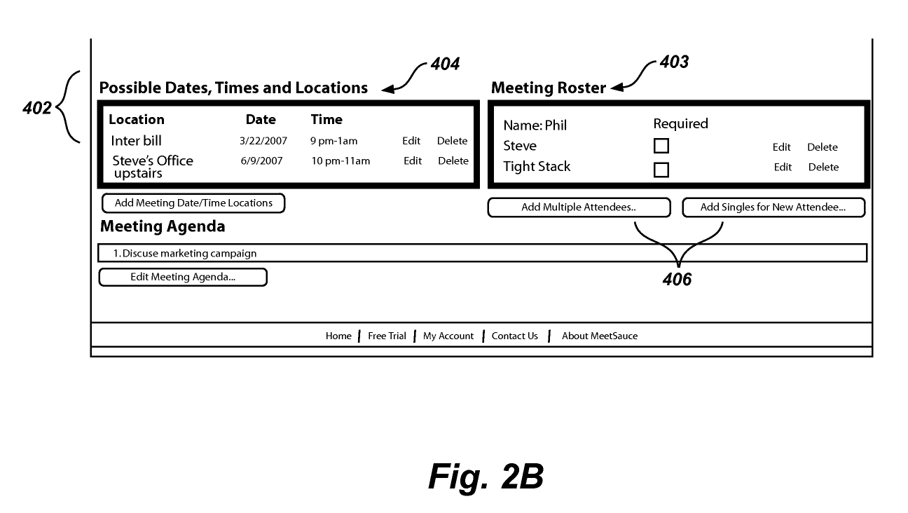

FIG. 2 shows the My Meetings interface generally as 401, wherein the Meeting Coordinator establishes new meetings and maintains pending or completed meetings. For each meeting, the Meeting Coordinator adds Meeting Attendees, Meeting Locations, establishes and modifies the meeting name, description, quorum and agenda, sends out meeting invitations and confirmations and monitors attendee responses.

The My Meetings page may comprise a list of active or pending meetings 402. When a meeting from the list 402 is selected, information for the selected meeting is displayed, including Meeting Attendees at the Meeting Roster section 403, Meeting Locations 404, the Meeting Agenda 405, Attendee Responses and whether or not consensus has been reached. The Meeting Coordinator is alerted via email or other means when meeting consensus has been reached so there is no need to continually refer to the system website for an update.

The Meeting Coordinator may add additional Meeting Attendees 406 and Meeting Locations 407 at any time. If an additional Meeting Attendee is added after invitations have been sent, an invitation will automatically be sent to the new Attendee.

If consensus is not reached for a meeting given the existing Meeting Locations, the Meeting Coordinator may add additional Meeting Locations and send out another round of invitations. This process can be repeated as many times as is necessary to reach a consensus.

The My Attendees section or webpage may be accessed through the Coordination Center and is similar to an address book, The My Attendees page is used to store contact information for meeting attendees, allowing the Meeting Coordinator to save attendee contact information for use in future meetings. Each stored attendee a record is maintained to store contact information such as email and telephone numbers, company, department position and title.

The My Locations section or webpage may be accessed through the Coordination Center and is similar to an address book, allowing the Meeting Coordinator to save locations for use in future meetings. Each stored location may include a detailed description of the venue, including seating capacity, amenities, reservation requirements and costs.

System Methods

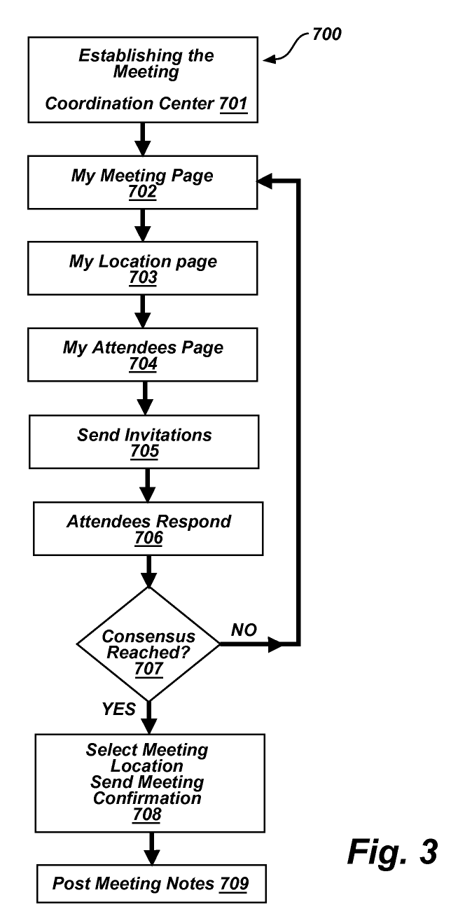

FIG. 3 outlines the process or methods generally 700 of coordinating a meeting.

The step of establishing a meeting 701 may start with the Meeting Coordinator accessing the Coordination Center and then accessing the My Meetings Page 702 wherein the Meeting Coordinator creates a new meeting and assigns a name to the meetings. Optionally, further meeting details may be recorded, such as the meeting description, quorum and agenda.

The next step may include accessing the My Locations page 703 and adding a meeting location by either selecting from the stored locations contained within My Locations or by creating new locations. The user or Meeting Coordinator may select multiple date/time/location combinations (Meeting Locations) for the meeting.

The next step may include accessing the My Attendees Page 704 and adding Meeting Attendees by either selecting from the stored attendees contained within My Attendees or by creating new Attendees. The Meeting Coordinator may select multiple Attendees and indicate for each if they are required or optional Attendees.

The next step may include sending invitations 705. When all the necessary meeting information, locations and attendees have been established the Meeting Coordinator may cause invitations to be sent out by simply clicking a “Send Meeting Invitations” button. The system then automatically sends an email to each Meeting Attendee containing all of the meeting information. An invitation may include links to the Meeting Locations and the Meeting Agenda.

The next step may include Attendees responding 706 by clicking the Meeting Locations link, the attendee is directed to a page on the system where they may select which meeting date/time/locations they can and cannot attend. Upon clicking the Meeting Agenda link the attendee is directed to a page on the system where they may review the Meeting Agenda, and optionally make recommendations for additions or changes to the Meeting Agenda.

As each Meeting Attendee responds to the Meeting Invitation and indicates which Meeting Locations they can attend, the system automatically calculates whether a Meeting Consensus has been reached.

The next step 707 may occur as soon as the system determines if a consensus has been reached. If all Attendees have responded and a Meeting Consensus has not occurred, the Meeting Coordinator may return to the My Meetings page 702 and add additional Meeting Locations, change dates and times, add, remove or change the required status of Meeting Attendees and send out another round of invitations. This process may be repeated as many times as is necessary to achieve a consensus.

When a consensus has been reached on one or more Meeting Location, the Meeting Coordinator may take the next step 708 and choose which Meeting Location to hold the meeting. The Meeting Coordinator has ultimate control over this selection process and is not limited to selecting a Meeting Location where a consensus has been reached.

Upon selecting the Meeting Location to hold the meeting the Meeting Coordinator when ready, may then send out the Meeting Confirmation emails. Much like the Meeting Invitations, the Meeting Confirmation is automatically generated and sent to all Meeting Attendees. The Meeting Confirmation may inform each attendee that the Meeting Coordinator has selected the specified date, time and location to hold the meeting. At this point, the coordination process is complete.

After a meeting has been held, the next step 709 may include the Meeting Coordinator exercising the option of posting the Meeting Notes upon a webpage or other posting means of the system. If the Meeting Coordinator so chooses, the Meeting Notes may be made public. Similar to the Meeting Invitations and Meeting Confirmation, the Meeting Notes may be automatically sent to the Meeting Attendees via email or other means.

Optionally, during a meeting, Meeting Attendees may access a system webpage and add meeting notes.

What is claimed is:

1. A method of scheduling meetings over a network comprising:
a) providing a meeting coordinator with an graphical user interface suitable for entering into a database the parameters of a new meeting including a name for the meeting;
b) providing a meeting coordinator with a graphical user interface suitable to optionally establish a meeting description, quorum or agenda for entry into a database;
c) providing a meeting coordinator with a graphical user interface comprising a my location page wherein meeting times may be selected, stored locations may be selected or new locations may be entered and selected from a database.
d) providing a meeting coordinator with a graphical user interface comprising a my attendees page wherein potential meeting attendees may be selected or new attendees may be established and selected from a database;
e) providing a meeting coordinator with means to define potential attendees as being required or optional;
f) providing a meeting coordinator with means to activate a send-meeting-invitations button causing electronic mail to be sent to all potential attendees;
g) providing to each potential attendee a hyperlink to a meeting locations page wherein a potential attendee is directed to another page wherein the potential attendee may indicate which meeting dates, times, and locations they can and cannot attend;
h) providing to each potential attendee a hyperlink to a meeting agenda page wherein each potential attendee may make recommendations for additions or changes to the meeting agenda;
i) after each potential attendee responds to a meeting invitation, comparing the meeting requirements to the responses and notifying the meeting coordinator when a meeting consensus has been reached.

2. The method of claim 1 wherein the meeting coordinator is notified by electronic mail when all potential attendees have responded and no consensus has been reached.

3. The method of claim 2 wherein the meeting coordinator may change meeting times, dates and locations, and change the required or optional status of potential attendees.

4. The method of claim 3 wherein all attendees may record notes during a meeting and such notes may be shared with all attendees.

5. The method of claim 4 wherein the notes recorded during a meeting are saved and attendees may later retrieve the notes.

6. The method of claim 5 wherein invitees may convey to the meeting coordinator their dates and times of availability for a meeting.

7. The method of claim 6 wherein a fee is charged to a meeting coordinator.

8. A coordination center for scheduling meetings and distributing agendas comprising:
a database;
a my meetings interface;
a my attendees interface;
a my locations interface; and
means of communicating to invitees.

9. The coordination center of claim 8 wherein the my meetings interface includes means of establishing a meeting name, description, quorum and agenda.

10. The coordination center of claim 9 wherein the my attendees interface includes means of selecting or adding potential meeting members to a mailing list.

11. A method of scheduling a meeting comprising the steps of:
entering meeting parameters into a database;
inviting participants to a meeting;
recording into the database the acceptances and rejections of the invited participates; and
scheduling a meeting when the invitees satisfy the meeting parameters entered into the database.

12. The method of claim 11 including means of recording statements made during a meeting.

13. The method of claim 12 wherein graphs are generated to display the status of filling the parameters of a meeting.

14. The method of claim 13 wherein fees are charged.

15. The method of claim 14 wherein an invited participant may invite others or sub-invitees to the meeting.
